(19) United States
(12) Patent Application Publication
(10) Pub. No.: US 2025/0008955 A1
(43) Pub. Date: Jan. 9, 2025

(54) AGRICULTURAL COMPOSITION

(71) Applicant: Yara UK Limited, York (GB)

(72) Inventors: Stuart WARD, York (GB); Laura HATHWAY, York (GB)

(21) Appl. No.: 18/711,715

(22) PCT Filed: Nov. 14, 2022
(86) PCT No.: PCT/EP2022/081750

§ 371 Date: May 20, 2024

(30) Foreign Application Priority Data
Nov. 19, 2021 (GB) 2116729.1

(51) Int. Cl. A01N 43/16; A01N 25/02; A01N 25/26; A01N 61/00; A01P 21/00

(52) U.S. Cl. CPC A01N 43/16; A01N 25/02; A01N 25/26; A01N 61/00; A01P 21/00

(57) ABSTRACT

The present disclosure provides a composition comprising a solvent selected from the group consisting of polyhydric alcohols. derivatives of poly hydric alcohols and mixtures thereof. and from 1.0 to 50 weight % of a compound selected from the group consisting of humic acids. fulvic acids, seaweed extract and mixtures thereof. This composition can be used as a coating composition on solid particles. in particular solid fertilizer particles. The present disclosure also provides a method for coating particles with a composition according to the present disclosure. comprising the steps of: a) providing solid particles. in particular solid fertilizer particles: b) applying the composition according to the present disclosure to the solid particles provided in step a).

### FIELD OF THE INVENTION

The present disclosure is related to the field of agriculture, in particular biostimulants.

### BACKGROUND OF THE INVENTION

In agriculture, biostimulants refer to substances and/or microorganisms applied to plants with the aim to enhance nutrition efficiency, abiotic stress tolerance and/or crop quality traits, regardless of its nutrients content.

Chemical substances such as humic and fulvic acids, protein hydrolysates, seaweed extracts, biopolymers, are considered biostimulants. Biostimulant microorganisms may be fungi or bacteria.

Biostimulants can be applied to the field in combination with other agricultural products, such as fertilizers, pesticides, or herbicides, or on their own. They are often applied as aqueous solutions.

However, there is now an interest to produce fertilizer particles coated with a coating composition comprising biostimulants. Coated fertilizer particles are a common product in agriculture. The coating composition may be used to improve physical characteristics of the particles and/or provide additional substances to the particles, such as micronutrients.

Aqueous solutions are not favored to coat fertilizer particles as the water contained in the composition may interact with the fertilizer components and weaken the structure of the particle.

There is a need to develop a new coating composition containing biostimulant components for particles, in particular fertilizer particles.

### SUMMARY OF THE INVENTION

In a first aspect, the present disclosure provides a composition comprising a solvent selected from the group consisting of polyhydric alcohols, derivatives of polyhydric alcohols and mixtures thereof, and a compound selected from the group consisting of humic acids, fulvic acids, seaweed extract and mixtures thereof.

In another aspect, the present disclosure provides a liquid composition comprising from 20 to 90 weight % of a solvent selected from the group consisting of polyhydric alcohols, derivatives of polyhydric alcohols and mixtures thereof, from 0 to 5.0 weight % of water, and from 1.0 to 50 weight % of a compound selected from the group consisting of humic acids, fulvic acids, seaweed extract and mixtures thereof.

In another aspect, the present disclosure provides a solid particulate composition comprising a solid particulate core substrate and a coating layer of a composition according to the present disclosure, wherein the coating layer contacts the solid particulate core substrate.

In another aspect, the present disclosure also provides a method for coating particles with a composition according to the present disclosure. The method comprises the steps of: a) providing solid particles, in particular solid fertilizer particles; and b) applying the composition according to the present disclosure to the solid particles provided in step a).

In another aspect, the present disclosure provides the use of the composition according to the present disclosure as a coating composition for solid particles.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

All references cited in this description are hereby deemed to be incorporated in their entirety by way of reference.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, in particular +/−10% or less, more in particular +/−5% or less, even more in particular +/−1% or less, and still more in particular +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “weight percent”, “% wt” or “weight %”, here and throughout the description unless otherwise defined, refers to the relative weight of the respective component based on the overall weight of the formulation.

In a first aspect, the present disclosure provides a composition comprising a solvent selected from the group consisting of polyhydric alcohols, derivatives of polyhydric alcohols and mixtures thereof, and a compound selected from the group consisting of humic acids, fulvic acids, seaweed extract and mixtures thereof. The composition may be suitable for use in agriculture, and in particular may be suitable for use as an agricultural biostimulant.

In another aspect, the present disclosure provides a liquid composition comprising from 20 to 90 weight % of a solvent selected from the group consisting of polyhydric alcohols, derivatives of polyhydric alcohols and mixtures thereof, from 0 to 5.0 weight % of water, and from 1.0 to 50 weight % of a compound selected from the group consisting of humic acids, fulvic acids, seaweed extract and mixtures thereof.

It was found that it was possible to prepare a composition, in particular a liquid composition, comprising biostimulant products, such as humic acids, fulvic acids, and/or seaweed extract. The biostimulant products are soluble in polyhydric alcohols, and the resulting composition can be used as a coating composition for solid particles, in particular solid fertilizer particles.

It was found that the coating composition according to the present disclosure is able to reduce the moisture absorption, the caking tendency, the ammonia volatilization and the dust emissions of particles coated with the present composition, and increase the hardness of coated particles.

Polyhydric alcohols refer to the group consisting of molecules comprising a carbon chain, which may be linear or branched, and at least two hydroxy groups. The group of polyhydric alcohols comprise diols, also named glycols such as 1,2-ethanediol, also named ethylene glycol, 1,2-propanediol, 1,3-propanediol, 1,2-butanediol, 1,3-butanediol, 1,4-butanediol, 1,2-pentanediol, 1,3-pentanediol, 1,4-pentanediol, 1,5-pentanediol; triols, such as 1,2,3-propanetriol, also named glycerol.

Derivatives of polyhydric alcohols comprise the compounds named above, where one of the hydroxy group has been substituted or modified. For example, the hydroxy group may have been tuned into an ether, an ester, or a carbonate. Derivatives of polyhydric alcohols also comprise polymers of the compounds cited above, such as diethylene glycol, triethylene glycol, and tetraethylene glycol. Derivatives of polyhydric alcohols also comprise derivatives of the polymers mentioned above, such as mono ethers, and diethers of polyethylene glycol, such as monomethyl diethylene glycol, monoethyl diethylene glycol, monopropyl diethylene glycol, monobutyl diethylene glycol, dimethyl diethylene glycol, diethyl diethylene glycol, dipropyl diethylene glycol, dibutyl diethylene glycol. The solvent may be of high purity, in particular it may be at least 98% pure, more in particular at least 99% pure.

The solvent may be a single chemical component, but it may also be a mixture of two or more glycols or glycol ethers. The solvent may be anhydrous or contain a small amount of water, such as less than 2.0 weight %, less than 1.5 weight %, or less than 1.0 weight %. Water is not desirable since it might degrade the fertilizer particle by dissolving some of the nutrients comprised in the fertilizer core, and negatively impacts some physical properties of the particle, such as the particle strength. But anhydrous solvents may be significantly more expensive than solvents comprising a small amount of water, such as less than 2.0 weight %, and a compromise may be acceptable. In one embodiment, the solvent comprises less than 2.0 weight % of water. In one embodiment, the solvent comprises less than 1.5 weight % of water. In one embodiment, the solvent comprises less than 1.0 weight % of water.

In one embodiment, the composition comprises from 20 to 90 weight %, from 30 to 90 weight %, from 40 to 90 weight %, from 50 to 90 weight %, from 60 to 90 weight %, from 70 to 90 weight %, from 20 to 80 weight %, or from 30 to 80 weight % of the solvent selected from the group consisting of polyhydric alcohols, derivatives of polyhydric alcohols and mixtures thereof.

In one embodiment, the solvent is selected from the group consisting of glycerol, monoethylene glycol, monopropylene glycol, diethylene glycol, 2-(2-ethoxyethoxy) ethan-1-ol, also known as diethylene glycol monoethyl ether, and mixtures thereof.

Fulvic acids and humic acids belong to the class of humic substances, a class of organic molecules that are obtained by decomposition of organic matter, in particular in soils, composts and peat bogs. Fulvic and humic acids are highly oxygenated macromolecules comprising substituted aromatic, such as phenols, and aliphatic hydrocarbons. Humic acids are not soluble in aqueous solutions with a very low pH, for example below 2, but soluble in mildly acidic, neutral and basic aqueous solutions. Fulvic acids are soluble in aqueous solutions, irrespective of the pH of the aqueous solution.

Sources of humic and fulvic acids are broadly available from commercial actors. For example, a product called BorreGro HA-1, sold by the Norwegian company Borregaard, comprises about 50 weight % of humic acids, and 20 weight % of fulvic acids. This product is produced by the method described in EP0786490A2. Humic and/or fulvic acids may be sold as complex mixtures containing other components, depending on the source of the acids.

Seaweed extracts are also compositions comprising a range of organic molecules and macromolecules, each component comprised in seaweed extracts may have a certain solubility in polyhydric alcohols.

In one embodiment, the compound selected from the group consisting of humic acids, fulvic acids, seaweed extract and mixtures thereof, is a obtained from leonardite and/or lignite.

As used herein, the terms “humic acids”, and “fulvic acids” also comprise the conjugated bases of the acid compounds.

In one embodiment, the composition comprises from 1.0 to 50 weight %, from 1.0 to 40 weight %, from 1.0 to 30 weight %, from 1.0 to 20 weight %, from 2.0 to 50 weight %, from 2.0 to 40 weight %, from 2.0 to 30 weight %, from 2.0 to 20 weight %, from 5.0 to 50 weight %, from 5.0 to 40 weight %, from 5.0 to 30 weight %, from 5.0 to 20 weight %, from 10 to 50 weight %, or from 10 to 40 weight % of a compound selected from the group consisting of humic acids, fulvic acids, seaweed extract and mixtures thereof.

In one embodiment, the composition comprises from 20 to 500 g/L, from 20 to 400 g/L, from 50 to 500 g/L, from 50 to 400 g/L, from 20 to 300 g/L, from 50 to 300 g/L, from 1000 to 500 g/L, from 100 to 400 g/L, or from 100 to 300 g/L of the compound selected from the group consisting of humic acids, fulvic acids, seaweed extract and mixtures thereof.

In one embodiment, the composition comprises humic acids and fulvic acids.

In one embodiment, the composition comprises from 20 to 500 g/L of humic acids, and/or from 20 to 500 g/L of fulvic acids. In one embodiment, the composition comprises from 20 to 400 g/L of humic acids, and/or from 20 to 400 g/L of fulvic acids. In one embodiment, the composition comprises from 20 to 300 g/L of humic acids, and/or from 20 to 300 g/L of fulvic acids. In one embodiment, the composition comprises from 20 to 200 g/L of humic acids, and/or from 20 to 200 g/L of fulvic acids.

In one embodiment, the composition further comprises an acid, in particular an organic acid, more in particular a dicarboxylic acid or a tricarboxylic acid, even more in particular an organic acid selected from the group consisting of malic acid, citric acid, malonic acid, maleic acid, fumaric acid and any mixture thereof.

In one embodiment, the composition further comprises from 0.1 to 10 weight %, from 0.1 to 5.0 weight %, or from 0.1 to 2.5 weight % of an acid, in particular an organic acid, more in particular a dicarboxylic acid or a tricarboxylic acid, even more in particular an organic acid selected from the group consisting of malic acid, citric acid, malonic acid, maleic acid, fumaric acid and any mixture thereof.

When the composition was applied as a coating onto a fertilizer particle comprising an ammonium source, for example calcium ammonium nitrate, it was noted that the particles emitted a strong and unpleasant smell. Upon analysis via a Drager tube, the smell was identified as being ammonia. Without being bound by theory, it is supposed that an element in the coating composition, for example the compound selected from the group consisting of humic acids, fulvic acids, seaweed extract, and any mixture thereof, may exhibit a basic character and catalyse the transformation of ammonium to ammonia. It was found that adding a component with an acidic character to the coating composition reduced the emission of ammonia during storage. A suitable acid needs to fulfil several criteria: acidic enough to stop the ammonia emission but it should not react or interact with the other elements of the fertilizer particle and/or the coating composition; preferably soluble in the solvent or solvent mixture used in the coating composition; preferably with a low health and safety risk to avoid complicating the use of the coating composition; commercially available at reasonable cost; preferably available pure or in an anhydrous solvent, however, it may be available as an hydrate complex. It was found that malic acid and citric acid are two chemicals fulfilling these criteria and are suitable to be added to the conditioning agent. Malic acid is a bis-carboxylic acid with pKas of 3.4 and 5.2, citric acid is a tri-carboxylic acid with pKas of 3.1, 4.8 and 6.4. It may be an advantage to lower the pH of the conditioning agent to about 8 or less, or 7 or less, or 6 or less to reduce the ammonia emissions from the fertilizer particles.

In one embodiment, the acid is an inorganic acid, such as boric acid. Boron is a micronutrient required by crops, so it may be an advantage to use boric acid as pH-decreasing agent because it also increases the agronomic value of the composition, whereas organic acids as discussed above do not. In one embodiment, the composition further comprises from 0.1 to 10 weight %, from 0.1 to 5.0 weight %, or from 0.1 to 2.5 weight % of boric acid.

The pH of the conditioning agent may be kept above 5. In one embodiment, the pH of the composition is from 6.0 to 9.0, 6.0 to 8.5, or from 7.0 to 8.5.

In one embodiment, the composition comprises an anti-foam agent. Such agent may facilitate the application of the composition onto solid particles. Examples of anti-foam agent are known in the field of formulation chemistry and include mineral oils, natural oils, and silicones. In one embodiment, the anti-foam agent is biodegradable.

In one embodiment, the composition is liquid at ambient temperature. A liquid composition is easier to apply on solid particles. In one embodiment, the composition is liquid at temperatures between 0 and 35° C. In one embodiment, the composition is liquid at temperatures between 10 and 35° C. In one embodiment, the composition is liquid at temperatures between 10 and 30° C.

In one embodiment, the composition is solid at ambient temperature. Depending on the melting temperature of the components of the composition, in particular of the solvent, the composition may be solid at ambient temperature. However, such compositions may still be used as coating composition on solid particles. Such compositions may be heated up above their melting or solidifying temperature, and be applied as a liquid to solid particles. Upon cooling the coating layer will solidify and harden, providing additional protection to the solid particles.

In one embodiment, the composition comprises a source of secondary nutrient and/or a source of micronutrient. Secondary nutrients are magnesium, calcium and sulphur. Micronutrients are boron, manganese, iron, copper, zinc, and molybdenum. The source of secondary nutrient and/or of micronutrient may be any source suitable for agricultural use. In particular, the source of the secondary nutrient may be a salt, such as magnesium sulphate, calcium nitrate, and ammonium sulphate, or an oxide, such as magnesium oxide and calcium oxide. The source of micronutrient may be a salt, such as iron sulphate, copper sulphate, copper nitrate, ammonium molybdate, sodium borate, zinc nitrate, and zinc sulphate, or a chelate, such as manganese ethylenediaminetetraacetate (MnEDTA), iron EDTA, copper EDTA, and zinc EDTA.

In one embodiment, the composition comprises from 1.0 to 50 weight % of a secondary nutrient and/or micronutrient.

In one embodiment, the composition is essentially anhydrous. In one embodiment, the composition does not comprise any added water. Some components of the composition may comprise a small amount of water, but it is preferred that the composition comprises as little water as possible because water may react with the solid particles.

In one embodiment, the composition comprises from 0 to 5.0 weight %, from 0 to 4.0 weight %, from 0 to 3.0 weight %, from 0 to 2.0 weight %, from 0 to 1.0 weight %, or from 0 to 0.1 weight % of water.

In one embodiment, the composition comprises from 5.0 to 30 weight %, or from 5.0 to 20 weight % of humic acids, from 1.0 to 20 weight % of fulvic acids, and from 50 to 90 weight % of a solvent selected from the group consisting of glycerol, monoethylene glycol and mixtures thereof.

In one embodiment, the composition comprises from 5.0 to 30 weight %, or from 5.0 to 20 weight % of humic acids, from 1.0 to 20 weight % of fulvic acids, from 50 to 90 weight % of a solvent selected from the group consisting of glycerol, monoethylene glycol and mixtures thereof, and from 0.01 to 2.0 weight % of citric acid.

In one embodiment, the composition comprises from 5.0 to 30 weight %, or from 5.0 to 20 weight % of humic acids, from 1.0 to 20 weight % of fulvic acids, from 50 to 90 weight % of a solvent selected from the group consisting of glycerol, monoethylene glycol and mixtures thereof, from 0.01 to 2.0 weight % of citric acid, and from 0.001 to 1.0 weight % of an anti-foam agent.

In one embodiment, the composition comprises a stabilizer or thickener agent, in particular from 0.1 to 10 weight %, from 0.1 to 5.0 weight %, from 1.0 to 5.0 weight %, from 0.1 to 4.0 weight %, from 0.1 to 3.0 weight %, or from 0.1 to 2.0 weight % of a stabilizer or thickener agent.

In one embodiment, the stabilizer or thickener agent is a cellulose-based product, such as fibrillated cellulose, or a clay, such as sepiolite clay. It may be an advantage to increase the viscosity of the composition by adding a thickener, so that the composition sticks better to the particles during the coating step and a thicker coating layer is obtained. The stabilizer may also prevent insoluble particles from precipitating and maintain the composition as an homogeneous composition.

Some of the components comprised in the composition may not be fully soluble in the solvent, especially at high concentrations. It may be an advantage to use an additive to act as a stabilizer or thickener agent to ensure that the composition remains homogeneous during storage. It was found that cellulose-based products, such as fibrillated cellulose, and clays were particularly efficient at stabilizing the compositions according to the present invention.

In another aspect, the present disclosure provides a solid particulate composition a solid particulate core substrate and a coating layer of a composition according to the present disclosure, wherein the coating layer contacts the solid particulate core substrate.

As used herein, a solid particulate composition refers to a composition containing solid particles. The solid particles are essentially identical in composition within a solid particulate composition.

It was found that the composition as described above was well adapted to be used as a coating composition on solid particles, in particular solid fertilizer particles. Coating particles with the composition as described above adds a small amount of the compound selected from the group consisting of humic acids, fulvic acids, seaweed extract and mixtures thereof, to the solid particles. In agriculture compounds such as humic acids, fulvic acids, and seaweed extract, are not required in large quantities by crops, so adding a coating layer to solid fertilizer particles allows distribution of fertilizer products and the biostimulants in a single operation for the farmer.

In one embodiment, the solid particulate core substrate is homogeneous, i.e. the solid particles used as core substrate are homogeneous. The solid particles used as core substrate may contain different components, but these components may be evenly distributed throughout the solid particles. For example, the solid particles may contain small fragments or pieces of a solid dispersed in a continuous matrix. In one embodiment, the solid particulate core substrate has an average particle size of 1.0 to 10 mm, measured by any standard techniques of the field, such as sieve analysis, laser diffraction, dynamic light scattering, or image analysis.

In one embodiment, the solid particulate core substrate has an average particle size of 1.0 to 10 mm, measured by any standard techniques of the field, such as sieve analysis, laser diffraction, dynamic light scattering, or image analysis, and comprises solid components with an average particle size at least 5 times or 10 times smaller than the average particle size of the solid particulate core substrate. In one embodiment, the solid particulate core substrate comprises solid components with an average particle size below 0.1 mm.

In one embodiment, the solid particulate composition comprises from 0.01 to 2.0 weight %, from 0.1 to 2.0 weight %, or from 0.1 to 1.0 weight % of a composition according to the present disclosure.

In one embodiment, the solid particulate core substrate comprises a component selected from the group consisting of urea, an ammonium salt, a nitrate salt, a phosphate salt, a potassium salt, and mixtures thereof. Urea, ammonium salts, nitrate salts, phosphate salts, and potassium salts are common sources of nutrients used in agriculture. These sources are used to provide nitrogen, in the form of urea, ammonium ions, or nitrate ions, phosphorus, in the form of phosphate salts, and potassium. Nitrogen, phosphorus and potassium are called primary nutrients in agriculture.

In one embodiment, the solid particulate core substrate comprises one or more elements selected from the group of magnesium, calcium, sulphur, boron, copper, iron, manganese, molybdenum, and zinc.

Magnesium, calcium, and sulphur are known as secondary nutrients in agriculture and boron, copper, iron, manganese, molybdenum, and zinc are known as micronutrients. Suitable sources for each nutrient are well known in the field.

In another aspect, the present disclosure also provides a method for coating particles with a composition according to the present disclosure. The method comprises the steps of: a) providing solid particles, in particular solid fertilizer particles; and b) applying the composition according to the present disclosure to the solid particles provided in step a).

In one embodiment of the method, the composition applied in step b) comprises from 20 to 90 weight % of the solvent selected from the group consisting of polyhydric alcohols, derivatives of polyhydric alcohols and mixtures thereof.

In one embodiment of the method, the solvent comprised in the composition applied in step b) is selected from the group consisting of glycerol, monoethylene glycol, monopropylene glycol, diethylene glycol, 2-(2-ethoxyethoxy) ethan-1-ol, also known as diethylene glycol monoethyl ether, and mixtures thereof.

In one embodiment of the method, the composition applied in step b) comprises from 2.0 to 50 weight % of the compound selected from the group consisting of humic acids, fulvic acids, seaweed extract and mixtures thereof.

In one embodiment of the method, the composition applied in step b) comprises humic acids and fulvic acid.

In one embodiment of the method, the composition applied in step b) further comprises citric acid.

In one embodiment of the method, the composition is applied in step b) such that the coated, solid particles comprise from 0.01 to 2.0 weight % of a composition according to the present disclosure.

In one embodiment of the method, the solid particles provided in step a) comprise a component selected from the group consisting of urea, an ammonium salt, a nitrate salt, a phosphate salt, a potassium salt, and mixtures thereof.

In another aspect, the present disclosure provides the use of the composition according to the present disclosure as a coating composition for solid particles.

In another aspect, the present disclosure provides the use of the composition according to the present disclosure as an agricultural product. The composition according to the present disclosure may be used directly as an agricultural product, for example, it may be distributed in the field using appropriate means. The composition may also be mixed with water or an aqueous solution, for example comprising fertilizer sources, and be distributed to the crops.

### Example 1

200 g of BorreGRO HA-1 was dissolved in 787 g of monoethylene glycol. BorreGRO HA-1 is a modified potassium humate derived from leonardite and commercialized by Borregaard, a company based in Norway. It contains approximately 50 weight % of humic acids, 20 weight % of fulvic acids, and 17 weight % of potassium, expressed as K₂O. 8.3 g of citric acid and 5.0 g of fibrillated cellulose were added to the mixture, which was stirred until homogeneous.

The density of the resulting composition is 1.17, its viscosity was measured on a spindle 3 Brookfield viscometer at 20° C. and 12 rpm: 200 cP. The composition had a pH of 7-8.

### Example 2

219 g of BorreGRO HA-1 was dissolved in 1000 g of monoethylene glycol. 16.6 g of citric acid and 1.2 g of an anti-foam agent were added to the mixture, which was stirred until homogeneous. The density of the resulting composition is 1.15, its viscosity was measured on a spindle 3 Brookfield viscometer at 20° C. and 12 rpm: 90 cP. The composition had a pH of 7.2.

The solution was stored for 8 weeks at 0° C., 20° C., and 45° C. The solutions stored at 0 and 20° C. showed some precipitation after already 1 week, whereas the solution stored at 45° C. remained fully dissolved.

### Example 3

219 g of BorreGRO HA-1 was dissolved in 1000 g of glycerol. 16.6 g of citric acid and 1.2 g of an anti-foam agent were added to the mixture, which was stirred until homogeneous.

The density of the resulting composition is 1.24, its viscosity was measured on a spindle 3 Brookfield viscometer at 20° C. and 12 rpm: 2100 cP. The composition had a pH of 7.4.

The solution was stored for 8 weeks at 0° C., 20° C., and 45° C., and remained fully dissolved.

### Example 4

280 g of BorreGRO HA-1 was dissolved in 500 g of monoethylene glycol and 500 g of glycerol. 8.3 g of citric acid and 1.2 g of an anti-foam agent were added to the mixture, which was stirred until homogeneous.

The density of the resulting composition is 1.29, its viscosity was measured on a spindle 3 Brookfield viscometer at 20° C. and 12 rpm: 340 cP. The composition had a pH of 8.6.

The solution was stored for 8 weeks at 0° C., 20° C., and 45° C. The solutions stored at 0 and 20° C. remained fully dissolved, and the solution stored at 45° C. showed some precipitation after 3 weeks.

### Example 5

200 g of BorreGRO HA-1 was dissolved in 973 g of monoethylene glycol. 8.3 g of citric acid and 5.0 g of sepiolite clay were added to the mixture, which was sheared until homogeneous.

The resulting composition has a density of 1.19, and a volume of 1.0 L. The viscosity of the composition was measured on a spindle 3 Brookfield viscometer at 20° C. and 12 rpm: 180 cP. The composition had a pH of 7-8.

### Example 6

286 g of BorreGRO HA-1 was dissolved in 1000 g of monoethylene glycol. 8.3 g of citric acid and 5.0 g of sepiolite clay were added to the mixture, which was sheared until homogeneous.

The density of the resulting composition is 1.20, its viscosity was measured on a spindle 3 Brookfield viscometer at 20° C. and 12 rpm: 340 cP. The composition had a pH of 8.6.

### Example 7

Calcium nitrate particles were obtained from Yara International (YaraTera Calcinit®) and coated with the composition of example 2 at rates of 1.5, 3, 6 and 12 liters/ton (L/MT).

Moisture absorption test: The coated particles and some uncoated particles were stored in a closed cabinet at ambient T and P. The particles were weighted before and after storage, the increase in mass being due to moisture absorption. The uncoated particles were used as reference point. The particles coated with 1.5 L/MT absorbed 12% less water than the uncoated particles, the particles coated with 3 L/MT absorbed 16% less water than the uncoated particles, the particles coated with 6 L/MT absorbed 7% less water than the uncoated particles, and the particles coated with 12 L/MT absorbed 2% less water than the uncoated particles.

Crush strength test: 20 particles of each type were crushed using a Mecmesin DT10 apparatus and the force required to break the particles was recorded. An average value over the 20 particles was calculated. The uncoated particles were used as reference point. The value obtained for the particles coated with 1.5 L/MT was 33% higher than the uncoated particles, showing a higher particle strength. The value obtained for the particles coated with 3 L/MT was 11% higher than the uncoated particles. The value obtained for the particles coated with 6 L/MT was 15% lower than the uncoated particles. The value obtained for the particles coated with 12 L/MT was 19% lower than the uncoated particles.

Caking test: A caking test was performed on uncoated calcium nitrate particles, and the same calcium nitrate particles coated with different compositions comprising humic acid (the coating loading is 3 L/MT for all examples): a water-based commercial product named Enersol comprising 18 weight % of humic and fulvic acids, a water-based commercial product named K Humate comprising 26 weight % of potassium humate and fulvate, and the composition according example 2. 100 g of a sample is placed in a plastic bag and sealed. The bag is stored for 24 hours at 45° C. A metal tile (weight =1.3 kg) is placed on top of the bag, and the bag is kept for another 24 hours at 45° C. The metal tile is then removed and the bag is left to cooled down to ambient temperature. The sample is then removed from the bag, and any caked material is weighted. In such experiment, the lower the cake weight, the better. The weight of the cake obtained was measured: 27.6 g for the uncoated particles, 9.6 g for the particles coated with Enersol, 31.9 g for the particles coated with the K Humate, and 1.4 g for the particles coated with the composition of example 2.

### Example 8

Ammonia volatilization tests: A test on ammonia volatilization was performed using urea particles (46% N): one batch of particles was uncoated while four other batches were respectively coated with: a water-based commercial product named Ferticoat comprising humic and fulvic acids, a water-based commercial product named K Humate comprising 26 weight % of potassium humate and fulvate, a 20 wt % aqueous solution of BorreGRO HA-1, and the composition according to example 2.

All coating compositions were applied at a rate of 4 liters/ton of urea particles. 0.43 g of particles were placed on 50 g of soil (pH=6.0, Norfolk loam topsoil), in a closed container containing a Dräger tube that measures ammonia emissions. The ammonia levels in the containers were regularly measured, and the results are presented in table 1 below.

TABLE 1

| Coating | T = 0 | T = 16 hours | T = 24 hours | T = 32 hours |
|---|---|---|---|---|
| None | 0 | 20 | 200 | 1300 |
| Ferticoat | 0 | 20 | 150 | 1300 |
| K Humate | 0 | 0 | 150 | 1150 |
| Water-based | 0 | 0 | 150 | 1150 |
| Borregro HA-1 | | | | |
| Example 2 | 0 | 0 | 150 | 1000 |

It can be seen in table 1 that the composition according to the present disclosure slows down the emissions of ammonia of urea-based particles.

### Example 9

Dusting test: Fertilizers particles of YaraMila NP loc 18.26.0 containing ammonium phosphate and ammonium nitrate, were tested for dust emission in a Heubach test, which is an internationally recognized test for dust emissions. Three types of particles were tested: uncoated particles, particles coated with a 20 wt % aqueous solution of BorreGRO HA-1 (4 liters/ton), and particles coated with the composition prepared in example 2 (4 liters/ton). For the uncoated particles, 2.6 mg was dust was captured, for the particles coated with the aqueous solution, 1.6 mg, and the particles coated with the composition of example 2 only 0.1 mg. The coating composition according to the present invention is excellent at reducing dust emissions from coated particles.

1. A liquid composition comprising from 20 to 90 weight % of a solvent selected from the group consisting of polyhydric alcohols, derivatives of polyhydric alcohols and mixtures thereof, from 0 to 5.0 weight % of water, and from 1.0 to 50 weight % of a compound selected from the group consisting of humic acids, fulvic acids, seaweed extract and mixtures thereof.

2. The composition according to claim 1, comprising from 30 to 90 weight % of the solvent selected from the group consisting of polyhydric alcohols, derivatives of polyhydric alcohols and mixtures thereof.

3. The composition according to claim 1, wherein the solvent is selected from the group consisting of glycerol, monoethylene glycol, monopropylene glycol, diethylene glycol, 2-(2-ethoxyethoxy) ethan-1-ol, and mixtures thereof.

4. The composition according to claim 1, comprising from 2.0 to 50 weight % of the compound selected from the group consisting of humic acids, fulvic acids, seaweed extract and mixtures thereof.

5. The composition according to claim 1 4, comprising humic acids and fulvic acid.

6. The composition according to claim 1, further comprising an acid selected from the group consisting of boric acid, malic acid, citric acid, malonic acid, maleic acid, fumaric acid and any mixture thereof.

7. The composition according to claim 1, wherein the composition comprises from 0 to 4.0 weight % of water.

8. A solid particulate composition comprising a solid particulate core substrate and a coating layer of a composition according to claim 1, wherein the coating layer contacts the solid particulate core substrate.

9. The solid particulate composition according to claim 8, comprising from 0.01 to 2.0 weight % of the liquid composition comprising from 20 to 90 weight % of a solvent selected from the group consisting of polyhydric alcohols, derivatives of polyhydric alcohols and mixtures thereof, from 0 to 5.0 weight % of water, and from 1.0 to 50 weight % of a compound selected from the group consisting of humic acids, fulvic acids, seaweed extract and mixtures thereof.

10. The solid particulate composition according to claim 8, wherein the solid particulate core substrate comprises a component selected from the group consisting of urea, an ammonium salt, a nitrate salt, a phosphate salt, a potassium salt, and mixtures thereof.

11. A method for coating particles with a composition according to claim 1, comprising the steps of:
a) providing solid fertilizer particles;
b) applying the composition to the solid particles provided in step a).

12. The method according to claim 11, wherein the composition is applied at a rate of from 1.0 to 20 liters/ton.

13. (canceled)

14. (canceled)
